(19) United States
(12) Patent Application Publication
(10) Pub. No.: US 2016/0063621 A1
(43) Pub. Date: Mar. 3, 2016

(54) BRIDGED WEEKLY FX FUTURES PRODUCT

(71) Applicant: Chicago Mercantile Exchange Inc., Chicago, IL (US)

(72) Inventors: Michael Dengis, Chicago, IL (US); Julie Winkler, Chicago, IL (US); Sandra Ro, London (GB); John Labuszewski, Westmont, IL (US)

(21) Appl. No.: 14/470,575

(22) Filed: Aug. 27, 2014

(51) Int. Cl. G06Q 40/04

(52) U.S. Cl. CPC G06Q 40/04

(57) ABSTRACT

A bridged weekly FX futures contract may include a series of weekly futures contracts extending over a specified time period, such as about 5 years. The series of contracts may be bridged such that long and short positions may be delivered into the next subsequent weekly contract of the same type. Upon delivery, a pass-through payment may be made from a long position to a short position, or vice versa, and may be contingent upon the relationship of spot and 1-week forward exchange rate values. The final contract in the series of weekly expiring FX futures contracts may result in an actual delivery of one currency vs. an equivalent amount of the opposite currency of the associated futures contract. By doing so, the bridged weekly FX futures contracts may allow a trader to maintain exposure in a desired currency pair over an extended or nearly perpetual period of time.

### BACKGROUND

Chicago Mercantile Exchange (later known as CME Group) pioneered the concept of rolling spot FX contracts in 1993. CME's goal at the time was to create a futures contract that replicated the economics of a continuously held position in spot currency, potentially over an extended period of time. The original offerings were based on the British pound, Deutsche mark and Japanese yen, vs. the U.S. dollar. These contracts were sized at four times the standard CME FX futures contract and aimed at an institutional audience.

Rolling spot futures were offered on the same 3-month cycle as other currency futures already listed by the CME at the time, with trading ending on the third Monday of March, June, September or December and delivery on the following Wednesday. These products deployed a feature such that the forward points associated with the contract would be debited or credited to the accounts of market participants. This feature was designed to insure that the contract would track spot price, eliminating the interest rate “carry” effect normally associated with futures or forward FX contract pricing. The products were traded from 1993 through about 1995.

However, the prior art contracts and corresponding systems are insufficient in various respects.

### SUMMARY

A bridged weekly FX futures contract may include a series of weekly futures contracts extending over a specified time period, such as about 5 years. The series of contracts may be bridged such that long and short positions may be delivered into the next subsequent weekly contract of the same type. Upon delivery, a pass-through payment may be made from a long position to a short position, or vice versa, and may be contingent upon the relationship of spot and 1-week forward exchange rate values. The final contract in the series of weekly expiring FX futures contracts may result in an actual delivery of one currency vs. an equivalent amount of the opposite currency of the associated futures contract. By doing so, the bridged weekly FX futures contracts may allow a trader to maintain exposure in a desired currency pair over an extended or nearly perpetual period of time.

The details of these and other embodiments of the present invention are set forth in the accompanying drawings and the description below. Other features and advantages of the invention will be apparent from the description and drawings.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows an illustrative trading network environment for implementing trading systems and methods according to at least some embodiments;

FIG. 2 shows a portion of an illustrative system for providing and pricing of a bridged FX futures contract in accordance with an aspect of the invention;

FIG. 3 shows an illustrative flow diagram 300 of a method for providing and pricing of a bridged FX futures contract in accordance with an aspect of the invention; and

FIG. 4 shows an illustrative chart including details of a bridged FX futures contract in accordance with an aspect of the invention.

### DETAILED DESCRIPTION

Bridged weekly FX futures contracts may be used to create an opportunity for customers to enjoy approximately continuous exposure to a currency over an extended period of time and/or on a nearly perpetual basis. As such, this concept may appear at the surface to be similar to a so-called “rolling spot” futures contract, a design pioneered by the Chicago Mercantile Exchange (CME) in 1992. While the purpose of the two concepts is similar, the bridged weekly FX futures contracts differ from the rolling spot designs in several key aspects. For example, the bridged weekly FX futures contracts may link a series of distinct weekly futures contracts that may be available over the course of a 5-year (or other suitably lengthy) term. The rolling spot design, on the other hand was based on the listing of a singular futures contract which expired some years in the future. Also, the bridged weekly FX futures contract may allow for the delivery of an expiring futures contract with the delivery of a subsequent futures contract plus (or minus) a cash payment. The final contract in the series of weekly contracts may be settled through normal delivery processes. Rolling spot futures, however, were distinctly different in that the rolling Spot futures may be settled at the conclusion of their lengthy single term through normal delivery processes.

The bridged weekly FX futures contracts may include a pass-through cash payment that comprises an element of the “delivery package” tendered in satisfaction of an expiring weekly contract. This cash payment may be determined by reference to spot/l-week forward foreign exchange rates. While the rolling spot contracts may also contemplate a pass-through cash payment, but on a daily basis and by reference to spot/next FX rates. Further, the cash pass-through payment associated with rolling spot contracts may be administered while maintaining the same rolling spot futures contract and not as part of a delivery process bridging subsequent futures contracts.

In some cases, a rolling spot contract may be used to provide an extended exposure for traders in a desired currency pair. However, rolling spot contracts associated with FX futures may entail a daily pass-through payment identified by reference to differential interest rates associated with the two currencies that comprise a currency pairing. As such, daily administration of the daily pass-through payment may be tedious and/or difficult to maintain. By providing a bridged weekly FX futures contract, administrative activities may be minimized and the associated costs may be reduced.

Further, a daily pass-through payment associated with an ongoing futures contract may require that bookkeeping systems be configured to account for such events. However, the financial exchange computing system may not be the only system affected by the rolling spot contracts. For example, many adjacent systems may not be owned or even administered by the financial exchange. As such, these adjacent systems must also be configured to accommodate the daily pass-through payment feature. By using bridged weekly FX futures contracts, the computing systems associated with the financial exchange and/or the adjacent systems may not require extensive reworking. For example, the use of the bridged weekly FX futures contracts may offer the advantage of using the familiar futures delivery process, with or without some limited modifications, and may create the long-term exposure. For example, a financial exchange may already have systems that can provide for the delivery of a cleared OTC swap in satisfaction of a futures contract in the form of Deliverable Swap Futures (DSFs). Further, cash payments are already part and parcel of a standard delivery process. Thus, infrastructure modifications would be minimized.

In some cases, the daily cash settlement concept used in the rolling spot concept may allow for traders to “push” the daily settlement price one way or the other to impact upon the execution price. The bridged weekly FX futures contract concept, on the other hand, may rely upon anonymously executed interbank FX transactions as a reference. As such, the settlement prices may be less readily “pushed.”

Bridged weekly FX futures contracts may be considered to be similar, in some respects, to a concept called “Roll at Trade Settlement” or “RATS,” also developed by CME Group. But again, the bridged weekly FX futures contracts may be distinguished from the RATS concept.

For example, RATS is an order entry type whereby a spread trade may be automatically executed at the daily settlement prices associated with the two futures contracts comprising the two legs of the spread within the existing futures contracts. By consistently using a RATS facility, a long-term or near perpetual exposure in the contract in question may be established. However, the distinctions are numerous. For example, RATS is an order entry type akin to Trade at Settlement (TAS) or Basis Trade at Settlement (BTIC). As such, RATS may be applied to any existing futures or derivatives contracts. Conversely, the bridged weekly FX futures contracts represent a system (or bundle) of weekly futures contracts linked through the weekly delivery process. Also, a RATS transaction may be completed at prices established by reference to the daily futures settlement prices. However, a pass-through cash payment that is coupled with the delivery of a Bridged Weekly FX futures contract may be identified by reference to the “pips” associated with one or more interbank FX spot/l-week forward transactions.

### Exemplary Operating Environment

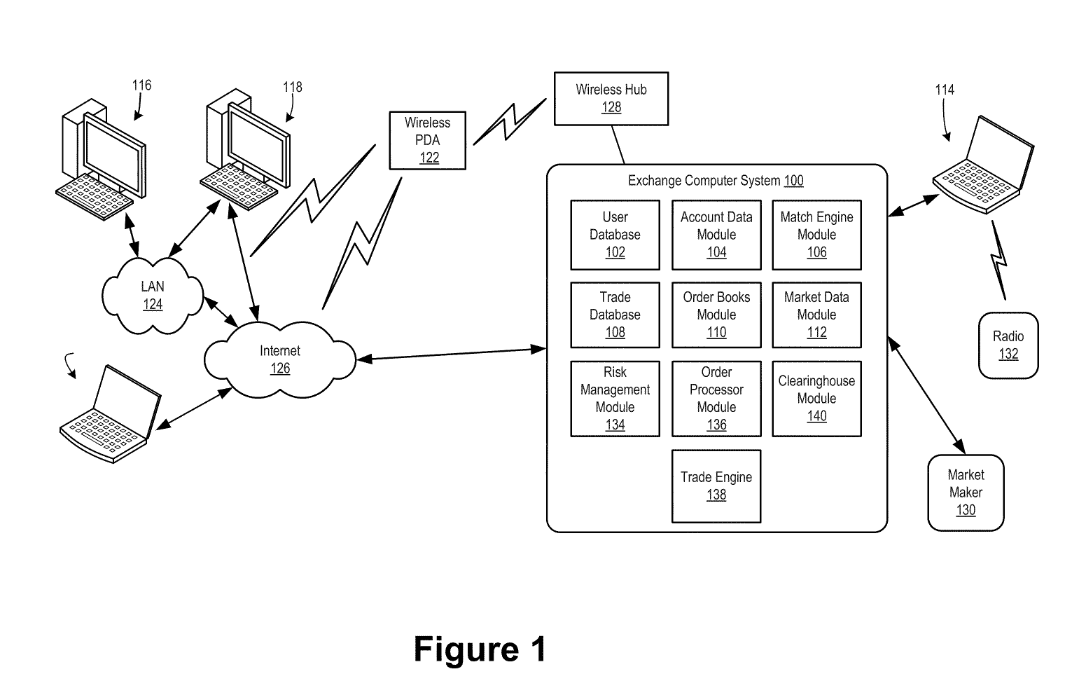

Aspects of at least some embodiments can be implemented with computer systems and computer networks that allow users to communicate trading information. An exemplary trading network environment for implementing trading systems and methods according to at least some embodiments is shown in FIG. 1. The implemented trading systems and methods can include systems and methods, such as are described herein, that facilitate trading and other activities associated with financial products based on currency pairs.

A computer system 100 can be operated by a financial product exchange and configured to perform operations of the exchange for, e.g., trading and otherwise processing various financial products. Financial products of the exchange may include, without limitation, futures contracts, options on futures contracts (“futures contract options”), and other types of derivative contracts. Financial products traded or otherwise processed by the exchange may also include over-the-counter (OTC) products such as OTC forwards, OTC options, etc.

The computer system 100 receives orders for financial products, matches orders to execute trades, transmits market data related to orders and trades to users, and performs other operations associated with a financial product exchange. An exchange computer system, such as the computer system 100, may be implemented with one or more mainframe, desktop or other computers. In one embodiment, a computer device uses one or more 64-bit processors. A user database 102 includes information identifying traders and other users of the computer system 100. Data may include user names and passwords. An account data module 104 may process account information that may be used during trades. A match engine module 106 is included to match prices and other parameters of bid and offer orders. The match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by the order book module 110 and the match engine module 106.

A clearinghouse module 140 may be included as part of the computer system 100 and configured to carry out clearinghouse operations. The clearinghouse module 140 may receive data from and/or transmit data to the trade database 108 and/or other modules of the computer system 100 regarding trades of futures contracts, futures contracts options, OTC options and contracts, and other financial products. The clearinghouse module 140 may facilitate the financial product exchange acting as one of the parties to every traded contract or other product. For example, an exchange computer system, such as the computer system 100, may match an offer by party A to sell a financial product with a bid by party B to purchase a like financial product. The clearinghouse module 140 may then create a financial product between party A and the exchange and an offsetting second financial product between the exchange and party B. As another example, module 140 may maintain margin data with regard to clearing members and/or trading customers. As part of such margin-related operations, the clearinghouse module 140 may store and maintain data regarding the values of various contracts and other instruments, determine mark-to-market and final settlement amounts, confirm receipt and/or payment of amounts due from margin accounts, confirm satisfaction of final settlement obligations (physical or cash), etc. As discussed in further detail below, module 140 may determine values for performance bonds associated with trading in products based on various types of currency pairs.

Each of modules 102 through 140 could be separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-140).

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may implement one or more of the well-known LAN topologies and may use a variety of different protocols, such as Ethernet. Computer devices 116 and 118 may communicate with each other and other computers and devices connected to LAN 124. Computers and other devices may be connected to LAN 124 via twisted pair wires, coaxial cable, fiber optics, radio links or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet. Computer devices 116, 118 and 120 may communicate with each other via the Internet 126 and/or LAN 124.

One or more market makers 130 may maintain a market by providing constant bid and offer prices for a derivative or security to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems (e.g., computer systems of clearing member firms), regulatory systems and fee systems.

The operations of computer devices and systems shown in FIG. 1 may be controlled by computer-executable instructions stored on non-transitory computer-readable media. For example, computer device 116 may include computer-executable instructions for receiving market data from exchange computer system 100 and displaying that information to a user. As another example, clearinghouse module 140 and/or other modules of exchange computer system 100 may include computer-executable instructions for performing operations associated with determining performance bond contributions associated with holdings in products that are based on various types of currency pairs.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

In some cases, the exchange computing system 100 may be configured to create and/or price an implied volatility derivative product based on an implied volatility of an underlying financial product. In at least some embodiments, the exchange computer system 100 (or “system 100”) receives, stores, generates and/or otherwise and processes data. In accordance with various aspects of the invention, the exchange computing system 100 may obtain pricing information corresponding to the underlying financial product from a financial market. This may promise a more straight-forward way for investors to take a position based on implied volatility of a financial product.

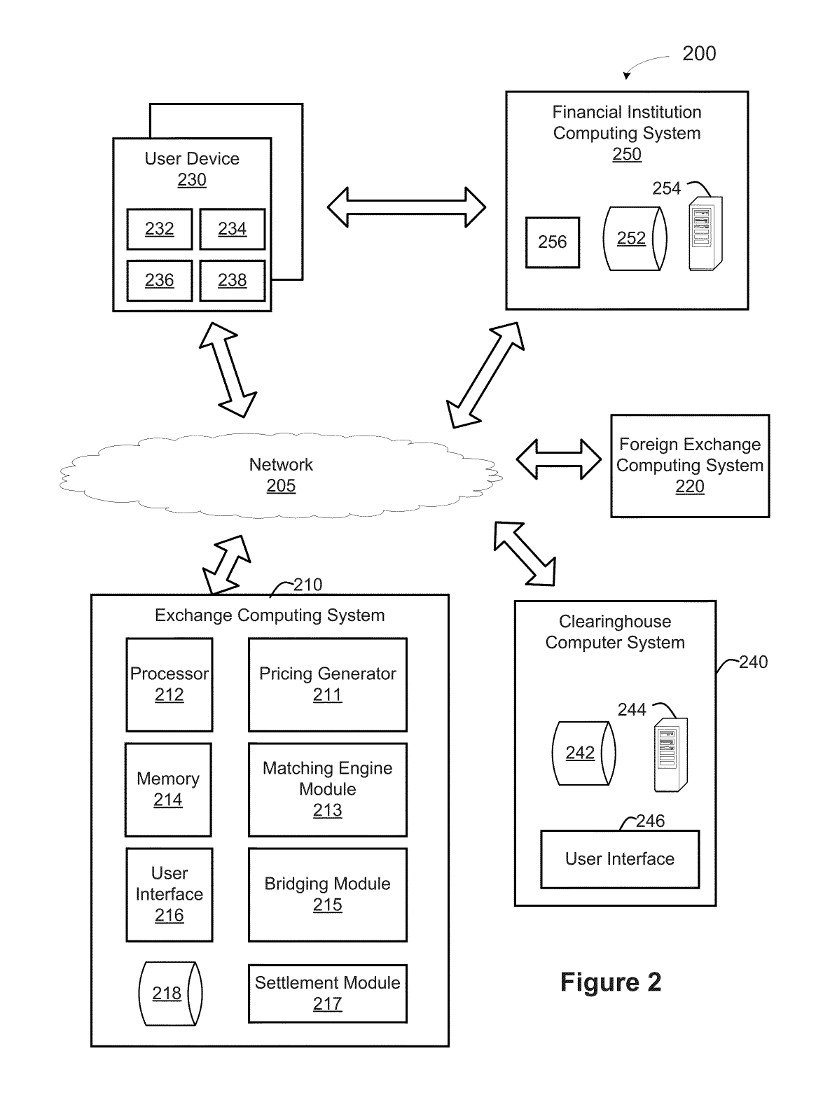

FIG. 2 shows a portion of an illustrative computing system 200 for providing and pricing of a bridged FX futures contract in accordance with an aspect of the invention. In some cases, the illustrative computing system 200 may include an exchange computing system 210, such as the exchange computing system 100 of FIG. 1. The illustrative computing system 200 may further include a foreign exchange computing system 220, one or more user devices 230, a clearinghouse computing system 240 and/or a computing system associated with each of one or more financial institutions (e.g., a bank, a broker, etc.), such as the financial institution computing system 250. In some cases, the clearinghouse computing system 240 may be incorporated into the exchange computing system 210. In other cases, the exchange computing system 210 may be separate, but communicatively coupled to the clearinghouse computing system 240 such as via the network 205. The exchange computing system 210 may be communicatively coupled to the foreign exchange computing system 220 via a network 205 (e.g., a wide area network (WAN), the LAN 124, the Internet 126, etc.). The exchange computing system 210 may include a data repository 212, one or more non-transitory memory devices 214 (e.g., RAM, ROM, a disk drive, a flash drive, a redundant array of independent disks (RAID) server, and/or other such device etc.)., a user interface 216 (e.g., a video monitor, an LED monitor, a touch screen device, etc.), and one or more processors, such as a processor 218. In some cases, a financial exchange associated with the exchange computing system 210 may desire to provide financial products, such as a series of bridged weekly FX futures contracts, to traders (e.g., individual investors, institutional investors, etc.) via a financial market. The series of bridged weekly FX futures contracts may be generated and/or processed by the exchange computing system 210 using information received from at least one of the foreign exchange computing system 220, the one or more user devices 230, the clearinghouse computing system 240 and/or the financial institution computing system 250.

The exchange computing system 210 may be configured to store instructions in the one or more memory devices 214 and/or the data repository 212 that, when executed by the processor 218, may configure the exchange computer system 210 to include one or more of a pricing generator 211, a matching engine module 213 (e.g., the match engine module 106), a bridging module 215 and a settlement module 217. Each of the pricing generator 211, the matching engine module 213, the bridging module 215 and the settlement module may be communicatively coupled within the exchange computing system 210 and/or may be communicatively coupled to the user device 230, the clearinghouse computer system 240, the foreign exchange computer system 220 and/or the financial institution computing system 250 via the network 205. In some cases, the data repository 212 may be any combination of general purpose and/or special purpose data storage devices and/or software. For example, the data repository 212 may include database software (e.g., a database management system) running on a dedicated server and/or on one or more shared devices. The data repository may include a database server (e.g., a dedicated computer system) configured to run a database management system for storing information corresponding to financial markets and/or financial accounts. In some cases, the data repository may further store instructions to configure the processor 218 to provide the functionality of the pricing generator 211, the matching engine module 213, the bridging module 215, and/or the settlement module 217.

The user interface 216 may include one or more user display devices (e.g., a CRT display, an LCD display, and LED display, a touchscreen device) and/or data entry devices (e.g., a keyboard, a mouse, a touchscreen, etc.). For example, the user interface 216 may include a keyboard and mouse to facilitate user interaction with information provide via a display device, such as a monitor. In some cases, the user interface 216 may be configured to provide and/or solicit information to/from users, such as by using one or more user interface screens. The user interface 216 may process instructions and/or access information (e.g., images, instructions, text, etc.) stored in the one or more memory devices 214 and/or the data repository 212 to generate the one or more user interface screens. In some cases, the user interface 216 may be provided locally to the exchange computer system 210, such as within a facility associated with a financial exchange. In other cases, the user interface 216 may be remote to a financial exchange facility. For example, the user interface 216 may be provided via the network 205 such via a remote device. In such cases, the exchange computing system 210 may be configured to provide user interface screens to the remotely located user interface 216. For example, the exchange computing systems may provide one or user interface screens to a remote device (e.g., the user device 230, the financial institution computing system 250, etc.) via the network 205. In such cases, the network 205 may be an open network (e.g., the Internet) or a closed network associated with the financial exchange and open to members of the financial exchange.

The processor 218 may include one or more microcontroller and/or microprocessors capable of processing instructions to provide one or more of the pricing generator 211, the matching engine module 213, the bridging module 215 the settlement module 217 and/or one or more user interface screens accessible via the user interface 216. The processor 218 may include a single core processor and/or a multi-core processor. In some cases, the processor 218 may include a distributed and interconnected set of processors, such as when the exchange computing system 210 is configured using a distributed computing model.

The processor 218 may be configured to process instructions and/or data stored in the one or more memory devices 214 and/or the data repository 212 to provide a bridged weekly FX futures contract. For example, the processor may process instructions to provide a bridged weekly FX futures contract as a series of weekly futures contracts extending over a specified time period, (e.g., about 1 year, about 5 years, about 10 years, etc.). The processor 218 may bridge each contract in the series of weekly futures contracts so that long and short positions may be delivered into the next subsequent weekly contract of the same type. Upon delivery of a weekly futures contract, the processor 218 may calculate and trigger an exchange of a pass-through payment between a long position to a short position, or vice versa. For example, the processor 218 may process instructions to calculate this pass-through payment contingent upon the relationship of spot and 1-week forward exchange rate values. In some cases, the processor 218 may settle the final contract in the series of weekly expiring FX futures contracts to facilitate an actual delivery of one currency vs. an equivalent amount of the opposite currency of the associated futures contract by the counterparties to the bridged weekly FX futures contract.

The financial exchange may offer the bridged weekly foreign exchange (FX) futures contracts, independently or to complement an existing FX product line offered in a currency exchange market. In some cases, the bridged weekly futures contracts may be based on major currency pairings that may include, but not be limited to, a Euro/US dollar (EUR/USD) pair, a US dollar/Japanese yen (USD/JPY) pair, a British pound/US dollar (GBP/USD) pair, a US dollar/Swiss franc (USD/CHF) pair, a US dollar/Canadian dollar (USD/CAD) pair, and an Australian dollar/US dollar (AUD/USD) pair. In some cases, the processor 218 may be configured to define one or more bridged weekly futures contracts using the bridging module 215. For example, the bridging module 215 may be configured to define the overall time period (e.g., about 5 years, about 10 years, etc.) associated with the series of bridged weekly FX futures contracts for a particular currency pairing, such as those listed above. In some cases, a user may select a length of the overall term associated with the series of the bridged weekly FX futures contracts. When a request to purchase or sell bridged weekly FX futures contract is received by at the exchange computer system 210, a purchasing party may be matched with a selling party by the matching engine module 213, such as the match engine module 106.

The bridged weekly FX futures contracts may be constructed by the bridging module 215 using a series of weekly futures contracts. The weekly FX futures contracts may be “bridged” to provide for continuous exposure over an extended, or nearly perpetual, period of time. The bridging module 215 may specify that at the expiration of the last in the series of bridged weekly FX futures contracts may trigger a delivery of the different currencies in the currency pairings between the counterparties of the futures contract. This delivery may be triggered at a date established at a time specified at the creation of the bridged weekly FX futures contracts, such as at a specified time in the future, such as a time five years from the original listing the series.

In some cases, the bridging module 215 may be used to “bridge” the individual weekly FX futures contracts in the series. For example, upon delivery of a long position in a bridged weekly FX futures contract, the customer may receive a long position in the subsequent week's contract. Similarly, upon delivery of a short position in a bridged weekly FX futures contract, the customer may receive a short position in the subsequent week's contract. Additionally, upon delivery of the bridged weekly FX futures contract, the bridging module 215 may determine a “pass-through” cash payment to be paid from a customer having a long position to a customer having a short position, or vice versa, as appropriate. In some cases, the pass-through payment may be determined used to reflect a value (e.g., in pips) of a spot/1-week forward agreement upon delivery of the subsequent week's contract. This calculated differential between the spot and 1-week forward exchange rates, may be established, such as by reference to one or more contemporaneous transactions by the bridging module 215.

As an example, traders in interbank foreign exchange markets seeking to maintain current currency exposures may commonly “roll over” spot positions using FX swap transactions. For example, Traders who are long spot currency might execute a roll by selling the currency on a spot basis and simultaneously buying it on a forward basis. Similarly, traders who desire to roll a short position may buy the currency on a spot basis, simultaneously selling on a forward basis. In such transactions, the counterparties may be committed to the actual exchange of two currencies on a specified date and at a mutually agreed upon exchange rate and a subsequent reversal of the transaction in the future at a different, mutually agreed upon exchange rate. In some cases, the transactions may be executed on a “spot/next” basis. In other words, the first transaction is completed with an actual exchange of currency on the spot value date, such as two business days after the date at which the transaction has been executed (e.g., a “spot” exchange). The subsequent reverse transaction may be completed on the next business day (e.g., a “next” day exchange). In another example, these transactions may be executed on a “spot/1-week forward” basis. For example, in the spot/1-week forward transaction, the transaction is unwound 1 week after settlement of the spot transaction. The bridged weekly FX futures contract may be used to replicate the spot/1-week forward transaction on an ongoing regular weekly basis, until the expiration of the defined time period associated with the bridged weekly FX futures contract, such as a date 5 years (e.g., 1 year, 10 years, 15 years, etc.) from the date of the initial listing of the series.

In some cases, pricing of the spot/1-week forward swap of the bridged weekly FX futures contract may reflect the relationship between interest rates associated with deposits in the two currencies of the bridged weekly FX futures contract. For example, an exchange rate may be quoted between U.S. dollars (USD) and Euros (EUR) in terms of USD per EUR. As such, USD may be considered to be the “terms” currency and EUR may be considered to be the “base” currency. In an illustrative example, the exchange computing system 210 may be configured to use the pricing generator 211 to calculate the pricing of the spot/1-week forward swaps and/or for determining the pass-through cash payment, such as by processing instructions to use the equations discussed below.

The forward price may be calculated using equation 1:

$$Forward Price = Spot Price \times ( \frac{1 + [ {R}_{term} \times ( \frac{d}{360} ) ]}{1 + [ {R}_{base} \times ( \frac{d}{360} ) ]} ) \qquad ( 1 )$$

For example, if the spot exchange rate equals 1.35 USD per EUR, the U.S. interest rate is 0.50% and the European interest rate is 0.20%. In such a case, the forward rate may then be calculated as 1.3500787 USD per EUR, as shown below.

$$Forward Price = 1.35 \times ( \frac{1 + [ 0.50 \% \times ( \frac{7}{360} ) ]}{1 + [ 0.20 \% \times ( \frac{7}{360} ) ]} ) = 1.3500787$$

The remainder (e.g., the premium) of 0.0000787 of 1-week forward vs. spot values may be referenced as forward points or “pips.” This premium of 0.0000787 pips may equate to $9.8375 based upon a [symbol] 125,000 unit (=0.0000787× [symbol] 125,000). In some cases, each currency pair may have a specified unit size (e.g., $100,000, [symbol] 125,000, £62,500, etc.). In some cases, the value may be positive when the terms rate is greater than the base rate or negative when the terms rate is less than the base rate.

When the premium is greater than 0, and the price of the forward trades increase at a successively higher level on the future trades, this situation is referred to as “negative carry”. Conversely, when the premium (e.g., pips) are less than 0 and the forward price of the forward trades increase at successively lower levels, this situation is referred to as “positive carry”.

When offering a bridged weekly FX futures contract, the exchange computing system 210 may list a series of weekly futures contracts. For example, a next trade in the series of trades comprising the bridged weekly FX futures contract may be listed at a specified time (e.g., 5 days, 1 week, 2 weeks, etc.) ahead of the expiration of the previous contracts. For example, a price for a successive contract may be listed approximately 2 weeks in advance of the last trading day for each previous weekly contract. As such, two weekly futures are available for consumers during this time. Upon expiration of the current active weekly futures contract, the current FX futures contract is settled through the delivery of a corresponding position in the subsequent weekly futures contract and may be coupled with a “pass-through” payment. For example, a long position in an expiring weekly futures contract may result in the delivery of a long position in the subsequent weekly contract and a short position in an expiring weekly futures contract may result in the delivery of a short position in the subsequent weekly contract. For example, when a long position in a Jun. 11, 2014 weekly contract is liquidated, via a book entry at a specified time (e.g., 8:00 AM (CT) on June 11^{th}, a long position in the next weekly FX futures contract (e.g., Jun. 18, 2014 weekly contract) may be simultaneously delivered to the corresponding account via a book entry. In this illustrative example, the exchange computer system 210 may trigger this exchange between the counterparties to the bridged weekly FX futures contract, such that a payment is made between an account associated with a first party and serviced by a first financial institution computing system 250, cleared by the clearinghouse computer system 240 and delivered into an account of a second party to the transaction and serviced by a second financial institution computing system 250.

In a positive carry environment, long positions delivered into a subsequent bridged weekly FX futures contract may be required to compensate corresponding short positions with a “pass-through” payment. For example, the pass-through payment may be equivalent to the spot/1-week forward pip value. In the example shown above, the accounts holding long positions may be debited $9.8375 per contract, while accounts holding short positions may be credited by the same amount. Similarly, in a negative carry environment, an account holding long positions delivered into a subsequent Bridged weekly FX futures contract may be eligible to receive a “pass-through” payment from an account holding short positions that may be equivalent to the spot/1-week forward pip value.

These pass-through payments may be administered by long and short clearing members of the Exchange, such as by the clearinghouse computer system 240. These payments are “pass-through” in the sense that the payments flow from the accounts of customers, as administered by a financial institution computing system. These payments executed by the financial institution computing system 250 are made through their respective Clearing Members, through the clearinghouse computing system 240, through additional Clearing Members and deposited into the accounts of the customers entitled to receive payment as done by the financial institution computing system 250. The pass-through values may be established by the pricing generator 211 of the exchange computing system 210 using a number of methods, such as by using observed 1-week forward transactions as actually consummated during a specified time period (e.g., a time period between 7:30-8:00 am (CT)). In some cases, a financial exchange, or subsidiary of the financial exchange, may transact 1-week forward trades in the currency in question to sample market values. For example, a subsidiary of a financial exchange may participate in a number (e.g. 2, 3, 4, 10, etc.) transactions, each having a similar face value (e.g., approximately $10 million) and including both buys and sells. The transacted pip values may be subjected to a volume-weighted average pricing (VWAP) process and may be referenced as the weekly pass-through value.

The final contract in the series of a bridged weekly FX futures contract may be settled through delivery of one currency vs. an equivalent value of the opposite currency. However, this final contract may not expire until a specified future date is met. In some cases, a final contract may not expire until 5 years after the initial listing of the series. As such, bridged weekly FX futures contracts may provide an opportunity for traders to hold a long term (e.g., very long term, virtually perpetual) position in a chosen currency pairing.

The foreign exchange computing system 220 may include one or more computing devices, data repositories, and/or user interfaces configured to facilitate trading in a foreign exchange (FOREX) market. The foreign exchange computing system 220 may be configured to facilitate buying and selling of currencies. For example, a trade performed by the foreign exchange computing system may involve buying of a first currency and a simultaneous sale of a second currency, as the value of the first currency is defined in term of the second currency. These currency pairs are thought of as a single unit that can be bought or sold.

The one or more user devices 230 may include a personal computer (e.g., the computer device 120), a tablet computer, a smart phone, or the like. The user device 230 may include a data repository 232, a memory 234, a user interface 236, and a processor 238. Each of the counterparties may be associated with a user device 230. The user device 230 may include a communication interface to communicatively couple the user device 230 to one or more of the financial institution computing system 250 and the exchange computing system 210. The user device 230 may be configured to process instructions stored in the memory 234 and/or the data repository 232 to present one or more user interface screens via the user interface 236. A user may request a purchase and/or sale of a bridged weekly FX futures contract via one or more of the user screens provided on the user interface 236.

The financial institution computing system 250 may be associated with a financial institution (e.g., a bank, a brokerage firm, etc.). The financial institution computing system 250 may include one or more computing devices 254, a data repository 252 and a user interface 256. The user interface 256 may be accessible to a user local to the financial exchange computer system, or may be capable of providing remote access via the network 205 to a user. For example, a user may access account or other financial information via one or more user interface screens displayed on the local user interface 256 and/or the user interface 236 of the remote user device 230. The data repository 252 may include information associated with one or more financial accounts of an individual investor and/or an institutional investor. In some cases, an investor may request a sale or purchase of a bridged weekly FX futures contract. In such an order, the investor may specify a sale or purchase of a particular bridged weekly FX futures contract associated with selected currency pair and/or a desired overall term (e.g., 5 years, 10 years, etc.).

Once the order is entered, an order request may be communicated via the network 205 to the exchange computing system. Each order may be subsequently matched with a counterparty by the matching engine module 213. Upon expiration of each of the weekly FX futures contracts, a pass-through payment may be triggered by the bridging module 215 of the exchange computing system 210 and cause the financial institution computing system 250 to initiate the pass-through payment between the counterparties. This pass through payment may be initiated electronically by the financial institution computing system 250 by communicating the pass through payment via the network 205 to the clearinghouse computer system 240 to be cleared. Once cleared, the clearinghouse computer system may communicate the payment to the financial institution computer system 250 associated with the second party for deposit into an associated account.

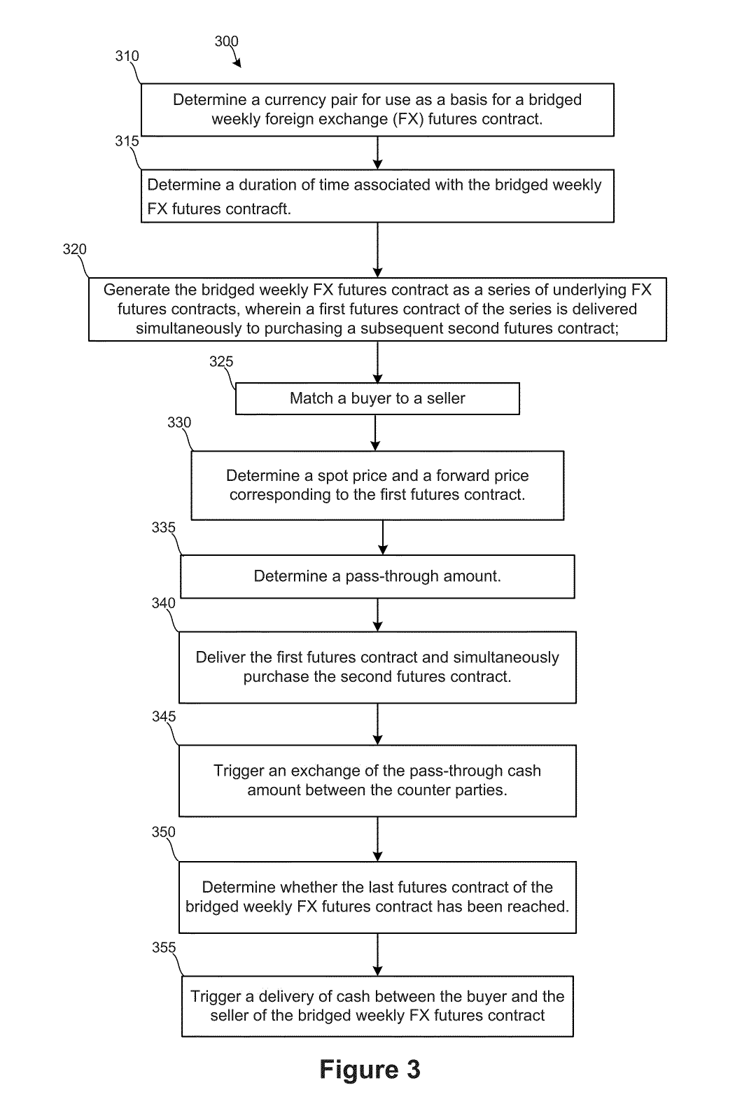

FIG. 3 shows an illustrative flow diagram 300 of a method for providing and pricing of a bridged FX futures contract in accordance with an aspect of the invention. In some cases, at 310, the exchange computing system 210 may be configured to determine a currency pair for use in creating the bridged FX futures contract. For example, the pricing generator 211 may be configured to create the bridged weekly FX futures contract such as by using a currency pair as defined in the one or more memory devices 214 and/or the data repository 212. In some cases, a trader may specify which currency pair (e.g., one of a Euro/US dollar (EUR/USD) pair, a US dollar/Japanese yen (USD/JPY) pair, a British pound/US dollar (GBP/USD) pair, a US dollar/Swiss franc (USD/CHF) pair, a US dollar/Canadian dollar (USD/CAD) pair, and an Australian dollar/US dollar (AUD/USD) pair, etc.) may be used as a basis for the bridged weekly FX futures contract. Similarly, at 315, the exchange computing system 210 may use the pricing generator 211, or other module, to determine a duration associated with a bridged weekly FX futures contract. For example, the pricing generator 211 may select a duration of a sufficient length (e.g., over 1 year, about 5 years, about 10 years, etc.) for use in creating the bridged weekly FX futures contract.

At 320, the pricing generator 211 or other module of the exchange computing system may be configured to generate the bridged weekly FX futures contract as a series of underlying FX futures contracts. The series of futures contracts may include a series of contracts where an active futures contract of the series is delivered simultaneously to purchasing a subsequent second futures contract. At 325, the matching engine module 213 may be used to match a buyer to a seller of the bridged weekly FX futures contract, where the buyer and the seller may be identified via orders entered using the user interface 236 of the user device 230 and/or the user interface 256 associated with the financial institution computing system 250.

At 330, the pricing generator 211 may be used to determine a spot price of the underlying FX futures contract and/or calculate a forward price the underlying FX futures contract, based on the current spot price and an interest rate associated with each of the currencies of the currency pair associated with the FX futures contract. In some cases, the spot price and/or interest rates associated with each of the underlying currencies of the currency pair may be obtained via the network from the foreign exchange computing system 220. At 335, the bridging module 215 may calculate a cash amount of a pass-through payment between the buyer and the seller of the bridged weekly FX futures contract, wherein the cash amount of the pass-through payment is based on a difference between the spot price and the forward price. At 340, the bridging module 215 may deliver the first futures contract and simultaneously purchase the second futures contract (e.g., the next contract in the series) and at 345 trigger an exchange of the pass-through cash amount between an account of the buyer and an account of the seller. At 350, the bridging module 215 may determine whether the last of the weekly FX futures contracts has been reached in the series of FX futures contracts. If so, the settlement module 217 may trigger a delivery of cash between the buyer and the seller of the bridged weekly FX futures contract. If not, the bridging module 215 continues to bridge the different weekly FX futures contracts of the series until the specified duration of the series has been reached.

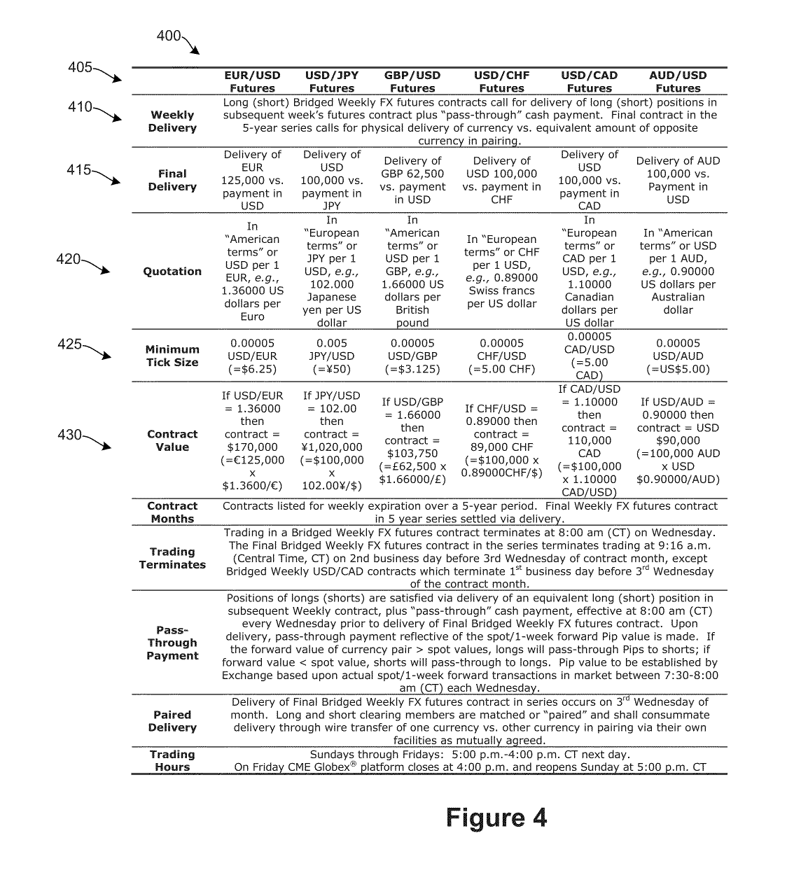

FIG. 4 shows an illustrative chart 400 including details of possible bridged FX futures contracts in accordance with an aspect of the invention. At 405, the chart includes columns associated with different possible currency pairs that may be used as a basis for the bridged weekly FX futures contract. For example, the exchange computing system 210 may provide one or more of a EUR/USD bridged weekly futures contract, a USD/JPY bridged weekly futures contract, a GBP/USD bridged weekly futures contract, a USD/CHF bridged weekly futures contract, a USD/CAD bridged weekly futures contract, an AUD/USD bridged weekly futures contract, and/or the like. The weekly delivery row 410 describes an illustrative delivery mechanism for the series of futures contracts used as part of the different bridged weekly FX futures contracts. At the Final Delivery row 415, the chart 400 describes a unit size of the currency pairs used in the bridged weekly FX futures contracts. For example, a unit size for a EUR/USD currency pair may be defined at EUR 125,000. Row 420 provides illustrative terms used in a quotation of the bridged weekly FX futures contract, such as in quoting USD per 1 UER, such as by stating 1.36000 US dollars per Euro in an illustrative example. Row 425 illustrates minimum “tick” sizes for the different currency pairs. Row 430 provides examples of contract values. For example, if a futures contract for a CAD/USD pair has a quotation of 1.1000 CAD/USD, then a contract may equal 110,000 CAD (e.g., 100,000 USD*1.1000 CAD/USD=110,000 CAD).

What is claimed is:

1. A system comprising:
a processor; and
a non-transitory memory device communicatively coupled to the processor, the non-transitory memory device storing instructions that, when executed by the processor, cause the processor to:
generate, by a pricing generator, a series of bridged weekly FX futures contracts, wherein an expiration of a first weekly FX futures contract coincides with an execution of a second weekly FX futures contract;
calculate, using the pricing generator, a price associated with the first weekly FX futures contract, wherein the price corresponds to a relationship between interest rates associated with deposits in two currencies of the series of bridged weekly FX futures contracts; and
calculate, by a bridging module, a pass-through payment from a first account associated with a first party associated with the first weekly FX futures contract to a second account associated with a second party associated with the first weekly FX futures contract.

2. The system of claim 1, wherein the non-transitory memory device stores further instructions that, when executed by the processor, cause the processor to:
identify, by the pricing generator, a currency pair underlying the bridged weekly FX futures contracts and a time period defining a duration of the series of bridged weekly FX futures contracts.

3. The system of claim 2, wherein the time period is greater than 2 years.

4. The system of claim 2, wherein the currency pair comprises one of a Euro/US dollar (EUR/USD) pair, a US dollar/Japanese yen (USD/JPY) pair, a British pound/US dollar (GBP/USD) pair, a US dollar/Swiss franc (USD/CHF) pair, a US dollar/Canadian dollar (USD/CAD) pair, and an Australian dollar/US dollar (AUD/USD) pair.

5. The system of claim 1, comprising:
a network communicatively coupled to the processor, wherein the non-transitory memory device stores further instructions that, when executed by the processor, cause the processor to:
receive, via the network, buy orders and sell orders for the bridged weekly FX futures contract; and
match, using a matching engine, a buyer of the bridged weekly FX futures contract with a seller of the bridged weekly FX futures contract.

6. The system of claim 5, wherein the non-transitory memory device stores further instructions that, when executed by the processor, cause the processor to:
receive, via the network from a financial exchange computing system, a spot exchange rate associated with an underlying currency pair and an interest rate associated with each currency of the underlying currency pair, wherein the price calculated by the pricing generator corresponds to a 1-week forward price.

7. A method comprising:
generating, by a pricing generator, a bridged weekly foreign exchange (FX) futures contract as a series of underlying FX futures contracts corresponding to an underlying currency pair, wherein a first futures contract of the series is delivered simultaneously to purchasing a subsequent second futures contract;
determining, by the pricing generator, a forward price associated with delivering the first futures contract and a simultaneous purchase of the second futures contract based on a spot price and interest rates associated with each currency in the underlying currency pair; and
calculating, by a bridging module, a pass-through payment as a difference between the spot price and the forward price.

8. The method of claim 7, comprising
receiving, via a network from a financial exchange computing system, the spot price associated with the currency pair, a first interest rate corresponding to a first currency of the currency pair and a second interest rate corresponding a second currency of the currency pair; and
calculating, by the pricing generator, the forward price using the spot price, the first interest rate and the second interest rate.

9. The method of claim 7, comprising
determining, by the bridging module, whether last weekly futures contract of the bridged weekly FX futures contract has been reached; and
initiating, by a settlement module at an end of the last weekly futures contract, settlement of the bridged weekly FX futures contract via delivery of a first currency of the underlying currency pair against an equivalent value of a second underlying currency of the currency pair.

10. The method of claim 7, comprising:
receiving, via a network, a buy order and a sell order for the bridged weekly FX futures contract; and
matching, via a matching engine, the buy order with the sell order for the bridged weekly FX futures contract.

11. An apparatus comprising:
a processor; and
a non-transitory memory device communicatively coupled to the processor, the non-transitory memory device storing instructions that, when executed by the processor, cause the processor to:
generate, by a pricing generator, a series of bridged weekly FX futures contracts, wherein an expiration of a first weekly FX futures contract coincides with an execution of a second weekly FX futures contract;
calculate, using the pricing generator, a price associated with the first weekly FX futures contract, wherein the price corresponds to a relationship between interest rates associated with deposits in two currencies of the series of bridged weekly FX futures contracts; and
calculate, by a bridging module, a pass-through payment from a first account associated with a first party associated with the first weekly FX futures contract to a second account associated with a second party associated with the first weekly FX futures contract.

12. The apparatus of claim 11, wherein the non-transitory memory device stores further instructions that, when executed by the processor, cause the processor to:
identify, by the pricing generator, a currency pair underlying the bridged weekly FX futures contracts and a time period defining a duration of the series of bridged weekly FX futures contracts.

13. The apparatus of claim 12, wherein the time period is at least 5 years.

14. The apparatus of claim 12, wherein the currency pair comprises one of a Euro/US dollar (EUR/USD) pair, a US dollar/Japanese yen (USD/JPY) pair, a British pound/US dollar (GBP/USD) pair, a US dollar/Swiss franc (USD/CHF) pair, a US dollar/Canadian dollar (USD/CAD) pair, and an Australian dollar/US dollar (AUD/USD) pair.

15. The apparatus of claim 11, comprising:
a network communicatively coupled to the processor, wherein the non-transitory memory device stores further instructions that, when executed by the processor, cause the processor to:
receive, via the network, buy orders and sell orders for the bridged weekly FX futures contract; and
match, using a matching engine, a buyer of the bridged weekly FX futures contract with a seller of the bridged weekly FX futures contract.

16. The apparatus of claim 15, wherein the non-transitory memory device stores further instructions that, when executed by the processor, cause the processor to:
receive, via the network from a financial exchange computing system, a spot exchange rate associated with an underlying currency pair and an interest rate associated with each currency of the currency pair, wherein the price calculated by the pricing generator corresponds to a 1-week forward price.

17. The apparatus of claim 11 wherein the non-transitory memory device stores further instructions that, when executed by the processor, cause the processor to:
deliver the first weekly FX futures contract;
purchase a second weekly FX futures contract in a same currency pair using a delivered position in the first weekly FX futures contract; and
transfer a pass-through cash payment representing a cash value difference between a cash value of the first weekly FX futures contract and a cash value of the second weekly FX futures contract.
